(19) United States
(12) Patent Application Publication
(10) Pub. No.: US 2019/0025939 A1
(43) Pub. Date: Jan. 24, 2019

(54) Cognition Enabled Predictive Keyword Dictionary for Smart Devices

(71) Applicant: International Business Machines Corporation, Armonk, NY (US)

(72) Inventors: Kushal S. Patel, Pune (IN); Sarvesh S. Patel, Pune (IN); Mark A. Shewell, Perth (AU); Gandhi Sivakumar, Victoria (AU)

(21) Appl. No.: 15/657,316

(22) Filed: Jul. 24, 2017

(51) Int. Cl. G06F 3/023; G06F 3/0488; G06F 17/27; G06F 3/0481

(52) U.S. Cl. CPC G06F 3/0237; G06F 3/04883; G06F 3/04817; G06F 17/276; G06F 17/273; G06F 3/04886

(57) ABSTRACT

An approach is provided that determines a user context that corresponds to a user of an information handling system. A number of predicted words are generated from various sources, with some of the words having a corresponding word-based context. The user context is compared to the word based context to identify at least one of the predicted words. The predicted words are displayed on a display device in a text messaging system utilized by the user, with the displayed word being selectable as a word to insert in a text message.

### BACKGROUND

### Description of Related Art

Modern Smartphone and smart devices like tablet PCs provides a mechanism to install social media applications. These applications are used to connect with users' social media account and professional email servers if email is configured. These applications are usually handled by Smartphone virtual keyboard interface for their general usage like composing emails, chatting window, etc. This keyboard interface manager (Dictionary) keeps the history of frequently used words and provides suggestion to user accordingly. Typically, the dictionary suggestions are totally dependent on dictionary learning and maintained counters inside the dictionary. When user enters any word then the word count to that word is increased and as per that the Smartphone dictionary suggests the word for user next time.

### SUMMARY

An approach is provided that determines a user context that corresponds to a user of an information handling system. A number of predicted words are generated from various sources, with some of the words having a corresponding word-based context. The user context is compared to the word based context to identify at least one of the predicted words. The predicted words are displayed on a display device in a text messaging system utilized by the user, with the displayed word being selectable as a word to insert in a text message.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a system diagram showing the various components used in providing a cognitive text prediction system;

FIG. 4 depicts a flowchart of a process that collects predicted cognitive words and contexts; and

FIG. 5 depicts a flowchart of a process that handles a predictive keyboard that prompts a user with predictive cognitive words.

### DETAILED DESCRIPTION

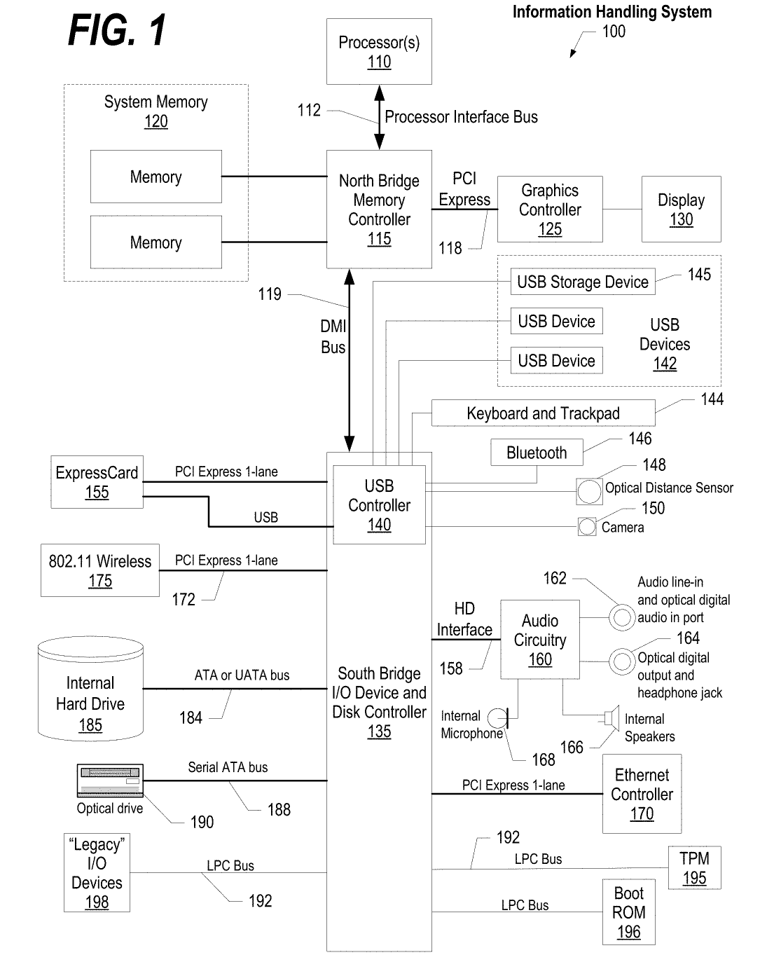

FIGS. 1-5 shows a cognition enabled predictive keyboard system that provides the word suggestions based on the provided parameters in summary section. This cognitive system provides more accurate suggestions for the user and considers user insights and in more customized way. This system works as keyboard predictor for an application or set of applications in smart device considering user's choices, history, priority and environmental conditions. Internet connected system also takes the news feed in that location based on user interest and suggest accordingly. This agent keeps performing the analysis of the words and requirement on every key stroke hence resulted in more natural, accurate and pleasantly word suggestions by predictive keyboards. The system uses the intelligent communication media for advice the audience picking inputs from static and dynamic platforms generating leads complying with time and situations.

Before the approach described herein, the available methods of dictionary keyboard suggestions were highly static and dependent on the counters of the words typed by user which does not consider the peripheral parameters. Today's dictionary software is not user constrained and provides general suggestions while typing. Also, the traditional approaches lag in cognition enablement in the dictionary which can learn from the call conversations, etc. There are many predictive text algorithms available form which majority comes either under dictionary based, or non-dictionary based systems. There are third party predictive systems like swiftkey which downloads the word from server side but there is no mechanism of word suggestion based on time and user peripheral considerations which are being addressed in this invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

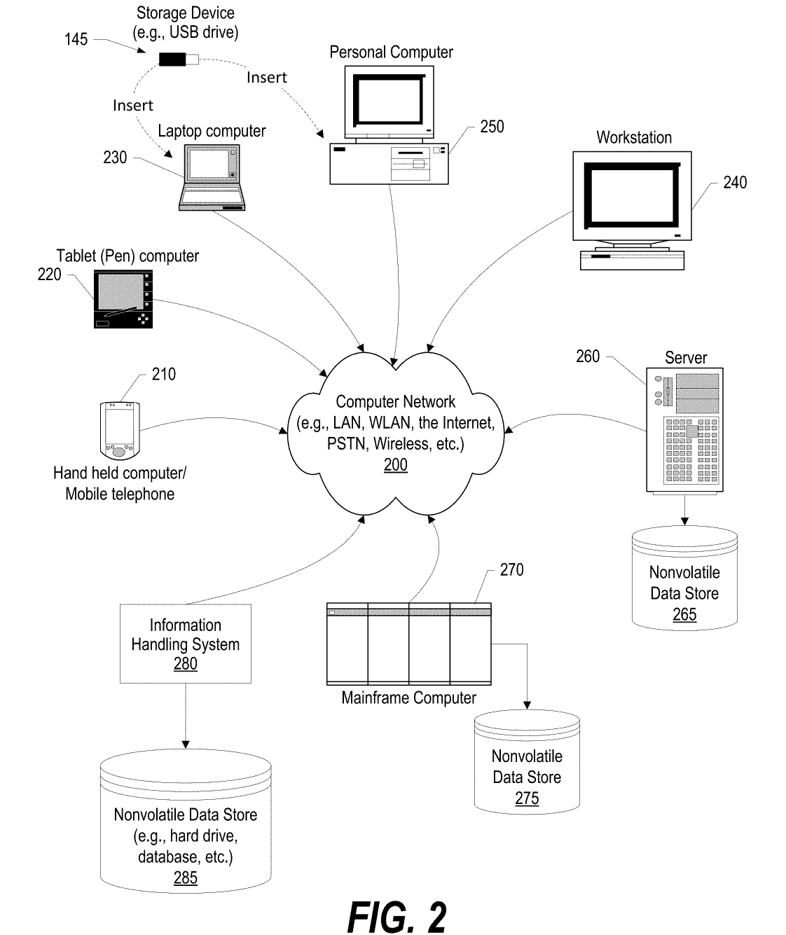

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

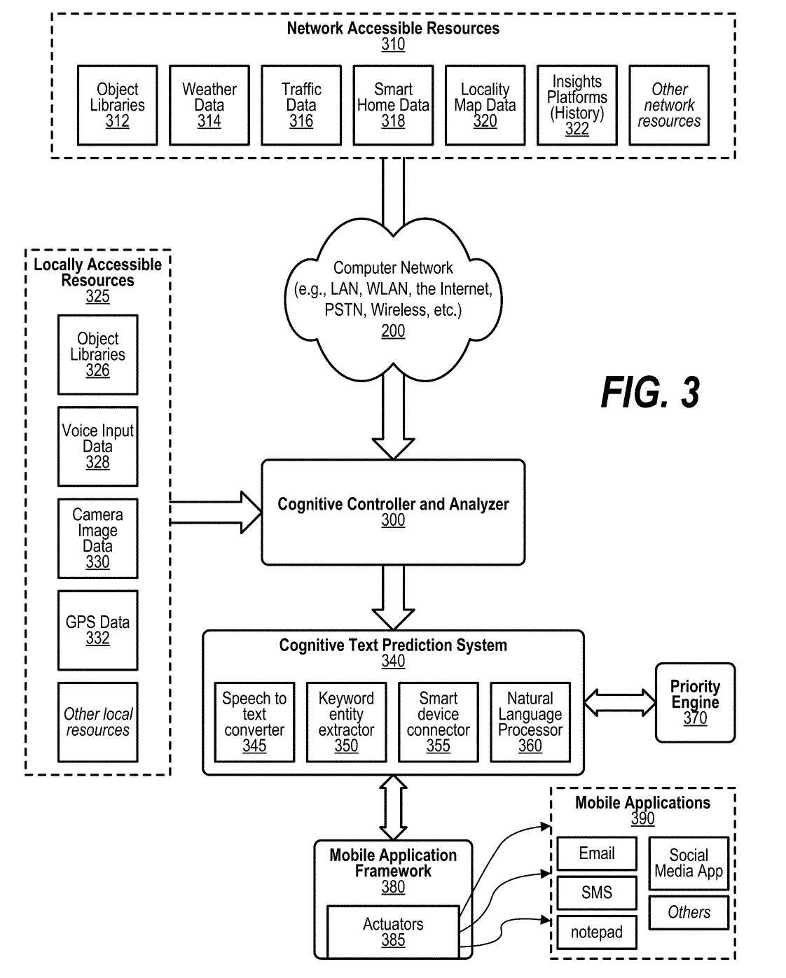

FIG. 3-5 depict a system diagram and a flowchart. Modern smart devices (such as smart phones, tablet PCs, etc) often have an integrated touch pad which is being used for viewing contents and also for typing with the help of a predictive keyboard which suggests upcoming words for super-fast typing. The word suggestions on keyboard are not perfect, and sometimes turn up hilarious results. As mentioned in the background section, these predictive keyboards are not enough intelligent and typically considers the word hit count and sequence while showing results. These predictive mechanism does not consider the peripheral things like users likes-dislikes, environmental parameter, and user's ecology.

This cognitive apparatus will serve as word and phrase predictor for smart device considering the user's personality insights, the location of the user, the specialty and famous things where the user is in and provide the dictionary suggestion to virtual keyboard interface accordingly. This apparatus also considers times, time zones and user colander along with history consideration of the age and other characteristics while showing the prediction results. Integrated weather discovery and news feeds makes this tool more intelligent and helps user to get the correct suggestions while typing. Cognitive analysis predicts the situations like traffic, surrounding noise, etc and based on that the dictionary suggestions are provides to the user. This cognitive apparatus also learns from the phone calls for the user's preferred words and suggest accordingly. The details with example are covered in Sample Claims section.

The approach described herein provides a method and an apparatus which co-exists with the available keyboard prediction systems for smart devices, recognize the surrounding of the user, typing pattern, time, identifies the weather conditions and maps it's with user's personality, considers typing habits, considers the user's location, the specialty of the location along with the major local news in that area and provides the keyboard predictions accordingly. This cognitive prediction for keyboard also considers the age and gender of the user while prompting up the suggestion word. The situations like traffic, power outage, surrounding noise are also being considered in this apparatus while popping the word prediction. The system also considers history, preferences and words in call conversations and provides predictive keyboard suggestions.

This approach can also be integrated with other enterprise mobility solutions to deliver a complete environment to develop apps and enable engagements that are designed specifically for mobile users. License cost can be generated where the system is integrated with an app builder that provides an environment to build the applications for smart phones. The system can further be integrated with API connect systems that provide a comprehensive solution to manage an entire API lifecycle from creation to management. The proposed approach can be plugged with messaging middleware that simplifies and accelerates the integration of diverse applications and business data across multiple platforms. In this manner, the approach delivers universal messaging with a broad set of offerings to meet enterprise-wide messaging needs, as well as connectivity for the Internet of Things (IoT) and mobile devices.

The approach described herein provides a GUI based interface integrated with current available keyboard systems termed as Cognition Enabled Predictive Keyboard which provides various functions such as the ability to consider user's choice, habits and surrounding and advice the dictionary words accordingly. The approach also provides the ability to prioritize the suggestions based on time, situation, occasion and environmental conditions. For example, if a user is on road with full of traffic and he started typing “I am in” then the system will prompt “Heavy traffic”. The approach also provides the ability to articulate insights based on the specific request by the user, if enabled, and act upon such. For example, if the system detects that the user is under 18 then the system should not prompt vulgar and offensive words. It should only prompt decorous words.

The approach can integrate with the personality based insights database and weather database and collects the information whenever required. For example, if it's raining outside and the user typed “It's” then the word will get prompted “raining”. Also, the system predicts interest of the user and suggests accordingly. This cognitive system can advise the user based on likes-dislikes and personalized selections made. The priority based advice is being made based on constraints. For example, if the user types “I like” then this tool will analyze a personality insights database about the user's likes and prompts next word as a like of the user, such as “Chicken soup.”

The approach also provides the ability to integrate with Smart Home initiate and monitor the user's activities to suggest the words in the predictive keyboards. For example, at night time when the user is watching television and had meal, he typed “Just had” then the suggestion pops up “dinner”. Likewise, at noontime, it will pop “lunch”. The approach also provides the ability to discriminate the time at user location and suggest accordingly. For example, if its 8:00 AM and user types “Good” then suggestion popped up is “Morning” and if its 5:00 PM then the suggestion will be “Evening.”

Integration with the location maps and the IoT interconnect provides the specialty of the location, prominent things at the location and applies the computation accordingly. For example, if the user is at Agra and tying “I am at”, then it prompts “Agra” and “train station”, “I saw” then the “Taj Mahal” is prompted. The approach also provides the ability to utilize network facilities to interconnect in order to communicate data to and from CE and mobile device for dictionary words prediction. The approach also provides the ability to learn the words from the voice calls on the user phone and consider them while typing. This also minimizes the dictionary maturation to learn the words.

The approach also provides the ability to fetch news feed based on users' interest and location and include them in computation. For example, if user is actively following sports and regular chats about the sports, then the famous sport news' keywords will be considered in prediction system. Ability to integrate user's daily routine and calendar and considers tasks, chores, or duties including near events like festivals, personal events like marriages, parties, meetings, etc. For example, if the user has a daily team meeting at 2:00 PM, and it is currently 1:55 PM and the user starts writing on chat window “I have ” then a prediction will prompt “a meeting now” to pop up. The approach also provides the ability to update the order, re-analyze when upon intervals, considering newer requirements, and suggest accordingly.

This approach provides a method that enables a system for cognition enabled predictive keyboard system for smarter devices as shown in FIGS. 3-5 discussed below. This approach optimizes the Smartphone dictionary heuristic word suggestion mechanism and provides more accurate predictions at the keyboard. This method considers the time, situation, location and other parameters which brings the dictionary and keyboard prediction more improved. This method enables environment awareness in Smartphone dictionary predictions. This can also be helpful for multilingual speakers who uses different language words in different applications and time, situations.

The approach also enables IaaS/PaaS service providers to provide more accurate and optimal real-time suggestions via predictive keyboards, based on the history-based learning and self-adjusting the monitoring levels based on real-time utilization helps user to get the desired words while typing. The approach also enables manufacturers of personal and embedded devices to provide more efficient monitoring of costumers, thus providing better predictions, hence resulting in greater customer satisfaction and increased business. This system works as keyboard predictor for an application or set of applications in smart device considering user's choices, history, priority and environmental conditions. Internet connected systems also retrieves news feeds in the user's location based on the user's interest and suggests words accordingly. This approach continues performing the analysis of the words and requirement on key strokes received from the user resulting in a more natural, accurate and pleasantly word suggestions by predictive keyboards. The approach provides a system that uses the intelligent communication media for advice with the users picking inputs from static and dynamic platforms generating words that comply with current time and situations, such as location or environment.

FIG. 3 depicts a system diagram showing the various components used in providing a cognitive text prediction system. Cognitive Controller and Analyzer process 300 receives data from both network accessible resources 310 as well as from locally accessible resources 325. Network accessible resources 310 includes object libraries data 312, weather data 314, traffic data 316, smart home data 318, locality map data 320, insights platforms (history) data 322, as well as any other network accessible resources. Network accessible resources are retrieved via computer network 200, such as the Internet. Locally accessible resources 325 includes local object libraries data 326, voice input data 328, camera image data 330, GPS data 332, and any other locally accessible resources.

Cognitive Controller and Analyzer process 300 provides data that is received and analyzed to Cognitive Text Prediction System process 340. Cognitive Text Prediction System process 340 includes sub-processes that include speech to text converter process 345, keyword entity extractor process 350, smart device connector process 355, and natural language process 360. The Cognitive Text Prediction System process interfaces with Priority Engine 370 that, in one embodiment, assists in prioritizing predicted words resulting from the Cognitive Text Prediction System process. The Cognitive Text Prediction System process also interfaces with Mobile Application Framework 380 that has a set of actuator processes 385 that correspond to various mobile application frameworks. Examples of Mobile Applications 390 supported by Mobile Application Framework 380 include email, SMS, notepad, social media apps, and other mobile applications.

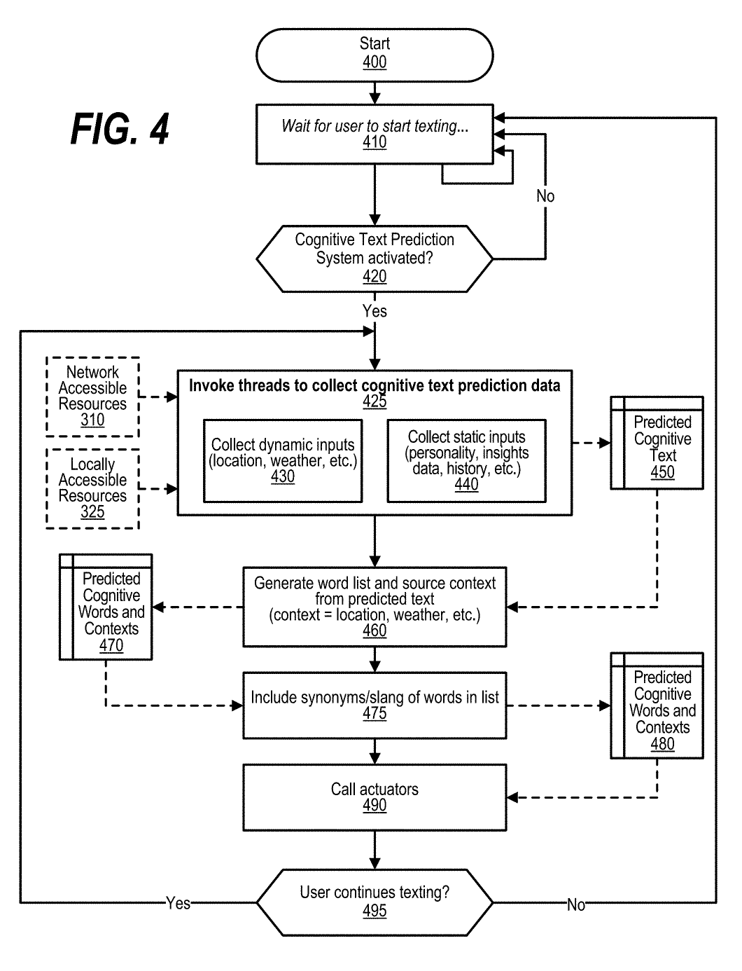

FIG. 4 depicts a flowchart of a process that collects predicted cognitive words and contexts. FIG. 4 processing commences at 400 and shows the steps taken by a process that collect cognitive text prediction data. At step 410, the process waits for user to start texting. This process spins, or loops, until it detects that the user has started texting. The process determines as to whether the Cognitive Text Prediction System has been activated by the user (decision 420). If the Cognitive Text Prediction System has been activated by the user, then decision 420 branches to the ‘yes’ branch to collect cognitive text prediction data. On the other hand, if the Cognitive Text Prediction System has not been activated by the user, then decision 420 branches to the ‘no’ branch which continues to wait for the user to activate the system.

At step 425, the process invokes threads that collect cognitive text prediction data from dynamic and static input data sources. The result of process 425 is predicted cognitive text data that is stored in memory area 450. In one embodiment, predictive cognitive text includes one or more “emojis” with an emoji being ideograms and smileys used in electronic messages and Web pages. Emoji are used much like emoticons and exist in various genres, including facial expressions, common objects, places and types of weather, and animals. For example, if a location context is that the user is in Paris, then an emoji might be a symbol of the Eiffel Tower. Likewise, weather emojis can be used to indicate that the weather is stormy, sunny, and the like.

The cognitive text prediction process retrieves data from both network accessible resources 310 as well as from locally accessible resources 325. At step 430, the cognitive text prediction process collects dynamic inputs, such as the user's location, the current weather, time of day, day of week, calendar data, and the like. At step 440, the cognitive text prediction process collects static inputs, such as the user's personality data (interests, hobbies, etc.), insights data, user history data, and the like. At step 460, the process generates a word list and a source context from the predicted text data 450 with the context being variables such as the current location, the current weather, etc. The predicted cognitive words and their corresponding contexts are stored in memory area 470.

At step 475, the process includes additional synonyms and/or slang versions of words in the list stored in memory area 470. This enhanced list of predicted cognitive words and their respective contexts are stored in memory area 480. At step 490, the process calls actuators corresponding tot he mobile applications with the actuators being provided the enhanced list of predicted cognitive words and their respective contexts from memory area 480.

The process determines as to whether user continues texting (decision 495). If the user continues texting, then decision 495 branches to the ‘yes’ branch which loops back to process 425 to continue collecting cognitive text prediction data and building the predicted cognitive words and contexts there from. This looping continues until the user is no longer texting, at which point decision 495 branches to the ‘no’ branch and processing loops back to step 410 to wait for the user to initiate another texting session.

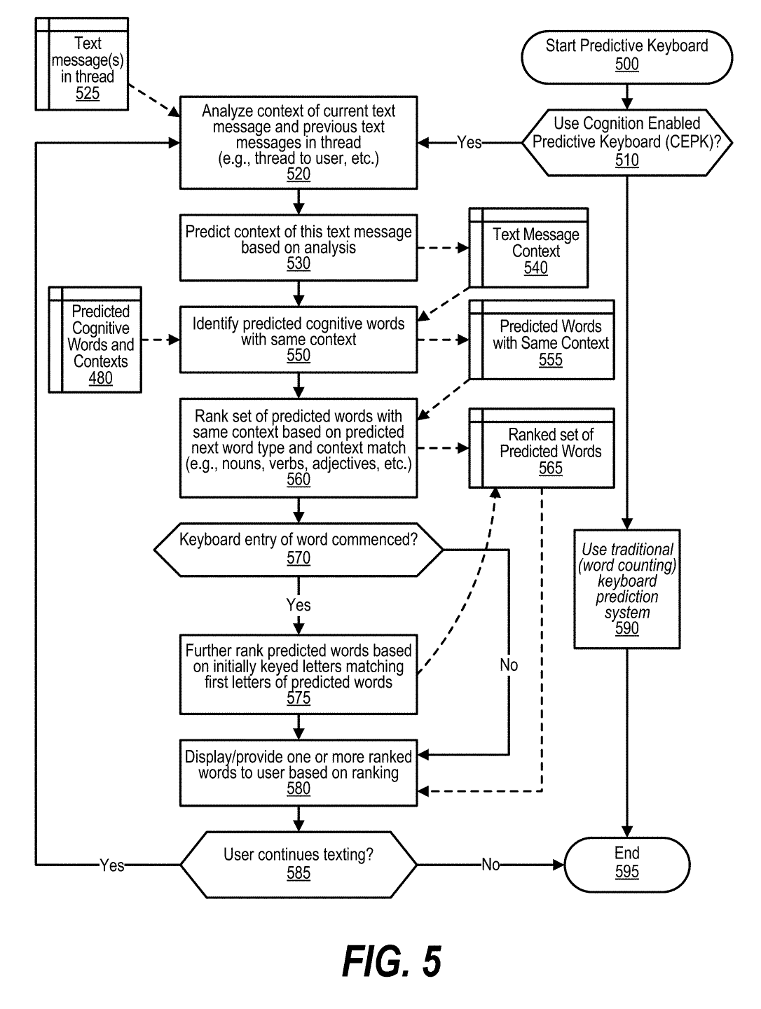

FIG. 5 depicts a flowchart of a process that handles a predictive keyboard that prompts a user with predictive cognitive words. FIG. 5 processing commences at 500 and shows the steps taken by a process that performs steps that display words on a predictive keyboard. The process determines whether the user has enabled the Cognition Enabled Predictive Keyboard (CEPK) (decision 510). If the user has enabled CEPK, then decision 510 branches to the ‘yes’ branch to perform steps 520 through 585 that handle the CEPK. On the other hand, if the user has not enabled CEPK, then decision 510 branches to the ‘no’ branch whereupon, at step 590, the process uses a traditional (word counting) keyboard prediction system and processing ends at 595.

When CEPK is being used then steps 520 through 585 are performed. At step 520, the process analyzes the context of the current text message and any previous text messages in the current thread (e.g., thread of messages to a particular user, etc.). The text messages are retrieved from memory area 525. At step 530, the process predicts the context of this text message based on the analysis performed at step 520. The context data is stored in memory area 540.

At step 550, the process identifies the predicted cognitive words from memory area 480 that have the same, or similar, context as the context stored in memory area 540. Note that multiple contexts can be identified, such as both a current location as well as a current weather (e.g., the user is in Denver and the weather is raining, etc.). The predicted cognitive words are stored in memory area 555. In one embodiment, predictive cognitive words include one or more “emojis” with an emoji being ideograms and smileys used in electronic messages and Web pages. For example, if a location context is that the user is in Paris, then an emoji might be a symbol of the Eiffel Tower. Likewise, weather emojis can be used to indicate that the weather is stormy, sunny, and the like.

At step 560, the process ranks the set of predicted words (that might include any number of emojis) from memory area 555 with the same context based on a predicted next word type and context match (e.g., nouns, verbs, adjectives, etc.). For example, if the user just typed “I'm in” the predicted next word type might be a noun that is a place and, using the previous example, the system might rank “Denver” as a leading predicted word based on the current text message and the context. In addition, an emoji symbolizing “mountains” might also be a leading predicted word based on Denver's proximity to the Rocky Mountains. The ranked set of predicted words is stored in memory area 565.

The process determines as to whether keyboard entry of a word has commenced by the user (decision 570). If keyboard entry of a word has commenced by the user, then decision 570 branches to the ‘yes’ branch to process step 575 whereupon the process further ranks the predicted words based on initially keyed letters matching first letters of predicted words. For example, if the user typed “The weather is” a leading predicted word might be “rainy”, but if the user typed a “b” then a leading predicted word based on the context might be “bad” instead of “rainy.” Likewise, if the initial letter was “s” then the predicted word “stormy” might be ranked higher than “rainy.” Returning to decision 570, if the user has not commenced keyboard entry of a word, then decision 570 branches to the ‘no’ branch bypassing step 575.

At step 580, the process displays and/or provides one or more ranked words to user based on the ranking. In one embodiment, the number of ranked words displayed is based on the application and/or device being used so that more predicted words can be displayed on a larger display, such as a laptop screen, whereas fewer words are displayed on a small display, such as on a smart phone.

The process determines whether the user continues texting (decision 585). If the user continues texting, then decision 585 branches to the ‘yes’ branch which loops back to step 520 to perform the steps discussed above. This looping continues until the user is no longer texting (e.g., closes texting session, etc.), at which point decision 585 branches to the ‘no’ branch exiting the loop and processing ends at 595.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system that includes a processor and a memory accessible by the processor, the method comprising:
determining a user context that corresponds to a user of the information handling system;
generating a plurality of predicted words from a plurality of sources, wherein one or more of the predicted words correspond to a word-based context;
comparing the user context with the word based context;
identifying at least one of the predicted words based on the comparison, and
displaying, on a display device accessible by the processor, the identified predicted word in a text messaging system utilized by the user, wherein the displayed word is selectable as a word to insert in a text message.

2. The method of claim 1 wherein the displayed word is an emoji.

3. The method of claim 1 further comprising:
identifying one or more of the plurality of predicted words from a plurality of network accessible resources, wherein at least one of the plurality of predicted words is selected from a group consisting of an object library, a weather data, a traffic data, a smart home data, a locality map data, and a set of history data.

4. The method of claim 1 further comprising:
identifying one or more of the plurality of predicted words from a plurality predicted words is selected from a group consisting of an object library, a voice input data, a camera image data, and a GPS data.

5. The method of claim 1 further comprising:
identifying one or more synonyms corresponding to at least one of the predicted words and including the identified synonyms in the plurality of predicted words.

6. The method of claim 1 further comprising:
ranking the plurality of predicted words based on a predicted next word type in the text message and a match between the user context and the word based context, wherein at least one of the user contexts is a location, wherein one or more of the plurality of predicted words is displayed based on the ranking.

7. The method of claim 6 further comprising:
receiving an initial letter as an input by the user to the text message; and
further ranking the plurality of predicted words based on the received initial letter.

8. An information handling system comprising:
one or more processors;
a memory coupled to at least one of the processors;
a display device accessibly by at least one of the processors and
a set of instructions stored in the memory and executed by at least one of the processors to perform actions comprising:
determining a user context that corresponds to a user of the information handling system;
generating a plurality of predicted words from a plurality of sources, wherein one or more of the predicted words correspond to a word-based context;
comparing the user context with the word based context;
identifying at least one of the predicted words based on the comparison, and
displaying, on a display device accessible by the processor, the identified predicted word in a text messaging system utilized by the user, wherein the displayed word is selectable as a word to insert in a text message.

9. The information handling system of claim 8 wherein the displayed word is an emoji.

10. The information handling system of claim 8 wherein the actions further comprise:
identifying one or more of the plurality of predicted words from a plurality of network accessible resources, wherein at least one of the plurality of predicted words is selected from a group consisting of an object library, a weather data, a traffic data, a smart home data, a locality map data, and a set of history data.

11. The information handling system of claim 8 wherein the actions further comprise:
identifying one or more of the plurality of predicted words from a plurality of locally accessible resources, wherein at least one of the plurality of predicted words is selected from a group consisting of an object library, a voice input data, a camera image data, and a GPS data.

12. The information handling system of claim 8 wherein the actions further comprise:
identifying one or more synonyms corresponding to at least one of the predicted words and including the identified synonyms in the plurality of predicted words.

13. The information handling system of claim 8 wherein the actions further comprise:
ranking the plurality of predicted words based on a predicted next word type in the text message and a match between the user context and the word based context, wherein at least one of the user contexts is a location, wherein one or more of the plurality of predicted words is displayed based on the ranking.

14. The information handling system of claim 13 wherein the actions further comprise:
receiving an initial letter as an input by the user to the text message; and
further ranking the plurality of predicted words based on the received initial letter.

15. A computer program product comprising:
a computer readable storage medium comprising a set of computer instructions, the computer instructions effective to cause an information handling system to perform actions comprising:
determining a user context that corresponds to a user of the information handling system;
generating a plurality of predicted words from a plurality of sources, wherein one or more of the predicted words correspond to a word-based context;
comparing the user context with the word based context;
identifying at least one of the predicted words based on the comparison, and
displaying, on a display device accessible by the processor, the identified predicted word in a text messaging system utilized by the user, wherein the displayed word is selectable as a word to insert in a text message.

16. The computer program product of claim 15 wherein the displayed word is an emoji.

17. The computer program product of claim 15 wherein the actions further comprise:
identifying one or more of the plurality of predicted words from a plurality of network accessible resources, wherein at least one of the plurality of predicted words is selected from a group consisting of an object library, a weather data, a traffic data, a smart home data, a locality map data, and a set of history data.

18. The computer program product of claim 15 wherein the actions further comprise:
identifying one or more of the plurality of predicted words from a plurality of locally accessible resources, wherein at least one of the plurality of predicted words is selected from a group consisting of an object library, a voice input data, a camera image data, and a GPS data.

19. The computer program product of claim 15 wherein the actions further comprise:
identifying one or more synonyms corresponding to at least one of the predicted words and including the identified synonyms in the plurality of predicted words.

20. The computer program product of claim 15 wherein the actions further comprise:
ranking the plurality of predicted words based on a predicted next word type in the text message and a match between the user context and the word based context, wherein at least one of the user contexts is a location, wherein one or more of the plurality of predicted words is displayed based on the ranking.
